(19) United States
(12) Patent Application Publication
(10) Pub. No.: US 2026/0133954 A1
(43) Pub. Date: May 14, 2026

(54) METHOD AND SYSTEM FOR DETERMINING DATA LINEAGE IN AN INTEGRATED OPERATIONAL TECHNOLOGY (OT)-INFORMATION TECHNOLOGY (IT) SYSTEM

(71) Applicant: Honeywell International Inc., Charlotte, NC (US)

(72) Inventors: Arnab Bhattacharjee, Bangalore (IN); Srikant Srinivasan, Bangalore (IN); Nikhil Bansal, Bangalore (IN)

(21) Appl. No.: 18/940,868

(22) Filed: Nov. 8, 2024

(51) Int. Cl. G06F 16/23; G06F 16/2455

(52) U.S. Cl. CPC G06F 16/2365; G06F 16/24566

(57) ABSTRACT

A method and system for resolving the data lineage in integrated operation technology (OT)-Information technology system (IT) is provided. The techniques described herein provides a solution for connected industries by enabling an Artificial Intelligence (AI)/Machine learning model (ML) to automatically trace the flow of data and identify the errors in data and provide a visual representation of the flow of data from a source to destination. The AI/ML model can uncover the hidden patterns with the help of historical data and validation techniques and make decisions to provide useful insight to downstream OT systems for automating a workflow. The present disclosure focuses on the onboarding of various OT systems data with a defined data structure into a database for efficiently and quickly resolving the data lineage of connected systems. The analysis performed by the AI/ML model is used for diagnosis and deviation prediction from a pre-defined key performance indicator.

### FIELD OF THE INVENTION

The present disclosure generally relates to integrated operational technology (OT) and information technology (IT) systems and particularly to a method and system for determining data lineage in OT-IT systems.

### BACKGROUND

The present disclosure provides a method and a system for determining the lineage of data in connected systems of an enterprise and to analyse the root cause of a fault in the event of an asset deviating from an expected optimal performance. Connected systems involve OT-IT systems working together in a data driven workflow. OT systems refers to physical systems that monitor and control assets. OT systems may include SCADA systems, distributed control systems (DCS), controllers, sensors and actuators etc. IT systems refers to systems that manage data, store information and facilitate business operations and analytical decision-making. IT involves databases, networks, software applications and cloud services. OT and IT systems generally operate in isolation as OT systems are designed for real-time control of industrial operations, whereas IT systems are focused on data management, reporting, and decision-making for business processes.

With the advent of modern digitalized industry, the convergence of OT and IT has become essential to improve efficiency, reduce costs, and enable smarter decision-making through data-driven insights. Connected systems involve integrating OT-IT data i.e. integrating data from sensors, actuators, DCS into IT systems for cloud storage for performing analytics and decision making. Data lineaging refers to the tracing of data flow from a source to the destination and the processing performed on the data. Data lineaging for connected industries is required to trace the flow of data and identify the errors in data and provide a visual representation of the flow of data from a source to destination. Visual representation of the flow of data from a source to the destination in connected systems enables a user to identify the fault in the performance of an asset and analyse the root cause. Data lineaging uncovers the hidden patterns with the help of historical data and validation techniques and make decisions to provide useful insight to downstream Operational Technology (OT) systems for automating a workflow of an enterprise.

Therefore, there is a requirement for the creation of specialized automated agents that may use the power of AI/ML techniques for automating a workflow of an enterprise. Some of these workflows are in the OT side (like control logic in a distributed control system (DCS) system) and some are in the IT side (Asset maintenance workflow). To get an overarching view of the enterprise, the configurations data from different systems are required to be collated to provide a lineage of how the data moves from one asset to another asset. The challenge, however, lies in the fact that the OT side presents data differently at the site or asset level, while the IT side uses an entirely different representation for the same enterprise. Thus, there is a lack of standard and naming convention as different systems are built over different time periods and often by different vendors. It is thus impossible to come up with a rule-based recognition system for an automated agent to discover the lineage. To integrate the data from systems into IT systems, the data from OT and IT systems are thus required to be standardized to onboard the OT-IT system data in a database.

To determine the data lineage and to efficiently identify the root cause of the fault causing the deviation in the assets performance, the standard of storing data in a database is significant. The standard of storing data in an OT system is required to be aligned with the standard of storage in an IT system to seamlessly onboard the OT-IT system data into a database and to retrieve the same on receiving a user input. Onboarding OT and IT configuration data in different standards would be disadvantageous as querying of the database is required to be performed on all the databases instead of a single query at the database of an asset located at the corresponding network levels of an enterprise.

OT systems often produce large volumes of data in real time, while IT systems handle the data for the purpose of analysis, storage, and business decision-making. Adopting standardized formats and storage protocols allows for smooth integration and data exchange between OT and IT systems. Storing data in a standard and onboarding the same in OT-IT systems ensures in maintaining the integrity of data when data flows between OT and IT systems. The standard of storing data is significant as assets from the OT environment and IT environment need to access and act on the same data, and to reduce errors in data when data flows from one asset to the other. Thus, the standards of storing data ensure that data lineage is traceable across both OT and IT systems. Further, adopting and adhering to these standards enables organizations to maintain data integrity, foster interoperability, meet regulatory requirements.

Thus, there is a need in the art that enables an AI/ML model to uncover the hidden patterns with the help of historical data and validation techniques and make decisions to provide useful insight to downstream Operational Technology (OT) systems for automating a workflow.

There is a further need in the art for onboarding of various OT system data with a defined data structure in a database for efficiently and quickly determining the data lineage of connected systems and for diagnosis and deviation prediction from the associated pre-defined key performance indicator (KPI) of the assets

There is a further need in the art to determine a data lineage chain that can trace the lineage of data and to monitor and rank the assets that are responsible for causing a deviation in the performance of the asset from the associated pre-defined key performance indicators of the assets.

### SUMMARY

The disclosure provides a method and a system for determining the lineage of data in connected systems. Data lineaging refers to the tracing of data flow from a source to the destination and the processing performed on the data. The present disclosure provides a solution for connected industries to trace the flow of data and identify the errors in data and provide a visual representation of the flow of data from a source to destination.

The disclosure enables an AI/ML model to uncover the hidden patterns with the help of historical data and validation techniques and make decisions to provide useful insights to downstream Operational Technology (OT) systems for automating a workflow. The present disclosure provides techniques on the onboarding of various OT systems data with a defined data structure into a database for efficiently and quickly determining the data lineage of connected systems. The analysis performed by the AI/ML model is used for diagnosis and deviation prediction from the associated KPI.

The input feed/data from the sensors/actuators and other components of the plurality of assets at the physical level (L0) is copied to assets at various levels, for example at L1, L2, L3, L3.5 and L4 etc. The data may also be transformed or calculated and fed to the assets at various levels depending on the relationship defined between the various assets.

The input feed or data from the plurality of assets at the physical level are copied or transformed to the assets namely Asset 1, Asset 2, Asset 3 . . . . Asset n located at same network levels or subsequent network levels of an industrial enterprise. When there is a deviation in the output data (for e.g. temperature, pressure or any other data), the observer system, shortlists relevant tags that may be a probable cause for the deviation in the output of the asset system and feeds the shortlisted tags to the AI/ML model for granular analysis.

The database is preferably a cloud-based database for example, GraphDB. In order to perform the analysis for determining the data lineage and to identify the root cause for the deviation in the one or more parameters of the asset, the input feed with relevant data from the physical level L0 is required to be stored in a predefined data structure. The relevant data that is required to be included in the data structure includes the identification of the asset, the identification of the network level, the identification of the destination asset, identification of the data channel for the asset, the relationship information identifying the destination asset and one or tags comprising tag values.

The method for determining the lineage of data in a connected system comprises receiving data associated with a plurality of assets located at one or more network levels of an industrial enterprise. The received data for each of the plurality of assets are stored in a database, wherein the received data comprises network level information of the asset, identification of a data channel for the asset, identification of a destination asset communicating via the data channel, relationship information identifying relationship with the destination asset and one or more tags, each tag comprising a tag value.

Each of the plurality of assets are monitored to identify a deviation from one or more associated key performance indicators (KPI) that are pre-defined by a user in the database. The database is then recursively queried, in response to the deviation to identify the one or more assets contributing to the deviation and to retrieve for each asset of the one or more assets, the one or more tags and associated tag values. The one or more tags and the associated tag values are fed to an artificial intelligence (AI) model, wherein the AI model is configured to dynamically analyse each of the one or more tags for determining a lineage chain to trace the lineage of data. The lineage of data and identification of the one or more assets contributing to the deviation is stored in the database.

The one or more tags in the data lineage chain are then ranked by the AI model based on the contribution to the deviation in a descending order and an interactive output is provided to an user interface. The AI model can now automatically determine new lineage of data based on the historical lineage data stored in the database. Further, as the database is configured to support recursive querying, the analysis is accurate, less time consuming and efficient.

Embodiments of the present disclosure features a system for determining lineage of data comprising: a processor, a memory storing program instructions which, when executed by the processor, causes the processor to: receive data associated with a plurality of assets located at one or more network levels of an enterprise, store for each of the plurality of assets, the received data in a database, wherein the received data comprises, network level information of the asset, identification of a data channel for the asset, identification of a destination asset communicating via the data channel, wherein the destination asset belongs to the plurality of assets, relationship information identifying relationship with the destination asset and one or more tags, each tag comprising a tag value. The processor is further configured to monitor each of the plurality of assets to identify a deviation from one or more associated key performance indicators (KPI). In response to the deviation, a recursive query is performed on the database to identify the one or more assets contributing to the deviation and retrieve for each asset of the one or more assets, the one or more tags and associated tag values. The one or more tags and the associated tag values are inputted to an artificial intelligence (AI) model, wherein the AI model is configured to dynamically analyse each of the one or more tags and determine a lineage chain to trace the lineage of data. The lineage of data and identification of the one or more assets contributing to the deviation are then stored in the database.

Embodiments of the present disclosure features a non-transitory computer readable medium storing software for determining lineage of data, the software including instructions for causing a computing system to: receive data associated with a plurality of assets located at one or more network levels of an enterprise, store for each of the plurality of assets, the received data in a database, wherein the received data comprises, network level information of the asset, identification of a data channel for the asset, identification of a destination asset communicating via the data channel, wherein the destination asset belongs to the plurality of assets, relationship information identifying relationship with the destination asset and one or more tags, each tag comprising a tag value. The software including instructions further causes a computing system to: monitor each of the plurality of assets to identify a deviation from one or more associated key performance indicators (KPI), in response to the deviation, recursively query the database to identify the one or more assets contributing to the deviation and retrieve for each asset of the one or more assets, the one or more tags and associated tag values, input the one or more tags and the associated tag values to an artificial intelligence (AI) model, wherein the AI model is configured to dynamically analyse each of the one or more tags and determine a lineage chain to trace the lineage of data and store the lineage of data and identification of the one or more assets contributing to the deviation in the database.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

FIG. 1 illustrates a general architecture of an industrial enterprise with integrated OT-IT systems.

FIG. 2 illustrates an example environment of an industrial enterprise for determining a data lineage in an integrated OT-IT system in accordance with an embodiment of the present disclosure.

FIG. 3 illustrates the mapping of a data structure of a source asset to a data structure of a destination asset for determining a data lineage in accordance with an embodiment of the present disclosure.

FIG. 4 illustrates an example system that may be configured for determining a data lineage in an integrated OT-IT system in accordance with an embodiment of the present disclosure.

FIG. 5A and FIG. 5B illustrates schematic diagrams illustrating the data flow from an asset located at a network level in the OT environment to the cloud database located in the IT environment in accordance with an embodiment of the present disclosure.

FIG. 6 illustrates a schematic diagram illustrating the tracing of data flow from one or more applications configured for an asset located at an OT network level to one or more applications configured in the cloud database at an IT network level in accordance with an embodiment of the present disclosure.

FIG. 7 illustrates an example interactive user output generated by a computing system running an AI/ML model in accordance with an embodiment of the present disclosure.

FIG. 8 illustrates a method for determining data lineage in OT-IT systems in accordance with an embodiment of the present disclosure.

### DETAILED DESCRIPTION OF THE INVENTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “module” as used herein with respect to components of a system or an apparatus should be understood to include particular hardware configured to perform the functions associated with the particular circuitry as described herein. The term “module” should be understood broadly to include hardware and, in some embodiments, software for configuring the hardware.

In connected industries, there is a requirement for creation of specialized agents that can automatically observe the data using AI/ML techniques. The specialized agents are capable of tracing the hidden patterns with the help of learning and human assisted validation techniques and are further capable of taking decisions to provide useful insights to downstream systems that can help automate a workflow.

The disclosure provides a method and a system for determining the lineage of data in connected systems. Data lineaging refers to the tracing of data flow from a source to the destination and the processing performed on the data. The present disclosure provides a solution for connected industries to trace the flow of data and identify the errors in data and provide a visual representation of the flow of data from a source to destination.

Connected systems refers to the integration of Operational technology (OT) systems and Information technology (IT) systems. Operational technology (OT) systems are physical systems and software that are required for monitoring and controlling physical processes and components in an industrial enterprise. Operational systems such as building systems (e.g., heating, ventilation, and air conditioning (HVAC) systems, building automation systems, security systems) and/or industrial systems (e.g., manufacturing systems, sorting and distribution systems) are configured to monitor and/or control various physical aspects of a premises, building, site, location, environment, mechanical system, industrial plant or process, laboratory, manufacturing plant or process, vehicle, and/or utility plant or process, to name a few examples.

OT systems form an essential part of an industry as they ensure safe and efficient physical operations. As the OT systems operate in real time, they are expected to maintain high reliability and continuous availability without downtime. Unreliability in its operation may lead to non-availability of the OT system for normal operations and hence can lead to manufacturing losses arising out of the downtime.

An OT system comprises various assets, including equipment (e.g., controllers, sensors, actuators) configured to perform the functionality attributed to the operational system and/or components, devices, and/or subsystems of the operational system. Assets are configured to execute one or more industrial processes and these assets typically generate, calculate, collect, and/or otherwise obtain various types of data related to the one or more industrial processes and output the data in a raw streaming format to one or more computing devices and/or one or more storage devices associated with an industrial enterprise related to the industrial environment.

An OT system for example, via its various assets, may monitor and/or control operation of a residential or commercial building or premises (e.g., HVAC systems, security systems, building automation systems, and/or the like). In another example context, the operational system may monitor and/or control operation of a manufacturing plant (e.g., manufacturing machinery, conveyor belts, and/or the like). In another example context, the operational system may monitor and/or control operation of a vehicle.

Often, a given industrial enterprise may be responsible for the management of several operational systems, across several sites and locations, each comprising several (e.g., possibly thousands) of assets. Management of such systems often includes monitoring conditions and/or performance of the systems' assets, facilitating and/or performing service on or physical maintenance of the assets, and/or controlling the assets in order to optimize the assets' and systems' performance and/or fulfill other objectives of the industrial enterprise.

IT systems refers to systems that can manage data, store information, and facilitate business operations and decision-making. IT involves databases, networks, software applications, cloud services to name a few. With the advent of modern digitalized industry, the convergence of OT and IT has become essential to improve efficiency, reduce costs, and enable smarter decision-making through data-driven insights. For seamless integration of OT and IT systems, the standard of onboarding the OT and IT data and naming convention plays a crucial role as OT system has a very different representation at a site or unit level and the IT side has another representation of the same industrial enterprise as different systems are built over different time periods and often by different vendors.

The traditional naming systems and the standard of storing the data in an asset may result in inefficient data processing and/or inefficient and limited data querying, thereby leading to an inaccurate tracing of data. Further, the traditional naming system and standard of storing data may result in an inaccurate understanding with respect to a real-time status, health, configuration, output, and/or operation of one or more assets within an industrial environment and hence necessitates multiple querying at each database, rather than a single query at a cloud database. The standard of storing data as detailed in the present disclosure enables accurate tracing of data from a source asset to a destination asset and hence provides real time status, health and output of the one or more assets within an industrial enterprise, thereby enabling a user to analyse the root cause in the event of a deviation from the pre-defined KPI.

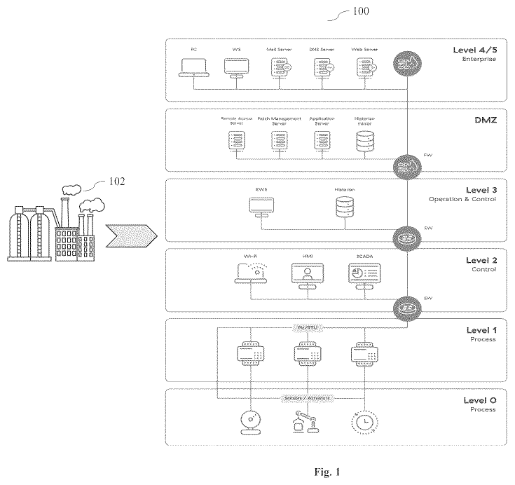

FIG. 1 illustrates a general architecture (100) of an industrial enterprise (102) with integrated OT-IT systems. The architecture (100) described herein groups the networks associated with the industrial control systems from enterprise networks and internet networks. The architecture separates various industrial control systems (ICS) and enterprise IT systems to ensure security and data flow. The architecture describes various network levels where network segments reside within the overall network of an industrial enterprise. The architecture further describes the description of various assets within a network level. The various network levels define the flow of data from physical devices in the OT system to the enterprise applications in the IT system.

The Level 0 is a device layer where various physical components and machineries exist. It includes sensors (measuring temperature, pressure, etc.) and actuators (valves, motors) that interact with the physical processes. The components and machineries located at this network level communicate with the components at the next network level through a dedicated channel using simple input output signals and hence there is an absence of internet networks at this network level. The next hierarchy Level L1 includes Programmable Logic Controllers (PLC), Distributed Control Systems (DCS) etc. that communicate with the sensors and actuators in L0 to collect data and to control the physical process of the industrial enterprise. The systems located at L1 is primarily for supervising, monitoring and controlling the physical process of the industrial enterprise. Level L2 is the layer that allows the operators to monitor and control processes, visualize data, and set operational parameter.

Level L3 is the layer where Manufacturing Execution Systems (MES) and Production Management Systems function. These systems oversee workflows, production scheduling, quality assurance, and the allocation of resources within the plant. The network level associated with these systems connects OT systems with IT infrastructure, using standard Ethernet and TCP/IP protocols. At level L3, data reliability and accuracy are prioritized as historical data storage and analysis are performed at this level. Level 3.5 is a network layer that serves as a buffer between the OT and IT networks. It enables secure data exchange between OT and IT systems, while protecting critical operational systems from potential security threats originating from the enterprise network. Level 4 systems include IT-based systems Enterprise Resource Planning (ERP) Systems that handle business logic, forecasting, procurement, and other activities. Level L5 includes cloud-based analytics, predictive maintenance systems, and Internet of Things (IoT) platforms that is capable of analyzing data across multiple plants or sites. The communication from level L4 to L5 is through Wireless Wide Area Network (WWAN) and is primarily used for analytics using machine learning techniques.

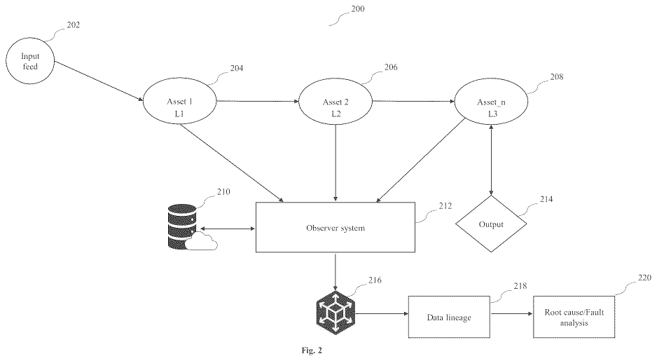

FIG. 2 illustrates an example environment (200) of an industrial enterprise for determining a data lineage in an integrated OT-IT system in accordance with an embodiment of the present disclosure. An input feed (202) or data measured by the sensors or actuators or components at the physical level is communicated to one or more assets (204, 206, 208 . . . n) located at the next or subsequent levels of an industrial enterprise. The measured data is communicated to an asset (204) which then subsequently communicates the received data to a different asset (206) at the same network level or to an asset located at the subsequent network level. In an example as illustrated in FIG. 2, the data from asset 1 may either be copied to asset 2 or the data may be transformed and communicated to the next asset based on the relationship information defined between the two assets.

The relationship information defines how a data is processed from one asset to the other asset and is determined based on the relationship defined between the two assets. For example, asset 1 (204) may be a boiler tank and asset 2 (206) may be a storage tank that is expected to maintain the temperature of the fluid received from the boiler tank, in which case the relationship between the two assets (204, 406) will be only a communication of the same data from asset 1 to asset 2.

The assets (204, 206, 208) as disclosed in FIG. 2 may be located at different network levels of an industrial enterprise or may be located at the same network level of an industrial enterprise. Similarly, the data received at asset 2 (206) may be communicated to multiple assets (204, 206, 208, . . . n) in an industrial enterprise. Assets as disclosed in FIG. 2 have been limited only for an illustrative purpose and for the purpose of simplicity. The KPI indicates the desired level of an output from an asset and is a set threshold value defined based on the historical performance of the assets in an industrial enterprise.

In an embodiment, systems engineers, owners, and operators (collectively “user(s)”) often attempt to track operational performance of a particular operational system, and/or asset(s) thereof, for any of a myriad of reasons. Among said reasons, such users often attempt to track operational performance of a particular asset (or plurality of assets) to determine when maintenance of such asset(s) is appropriate. For example, as an asset operates, the operation of the asset and/or changes in one or more circumstances associated with the operation of the asset may cause the asset's performance to begin to deteriorate, with such deterioration continuing until the asset deteriorates so much that it no longer can operate reliably for its intended purpose (e.g., the asset has no remaining useful lifetime). The deterioration in assets performance will be identified by the user on monitoring the output (214) of the asset(s). Maintenance of the one or more asset(s) may be performed based on the monitoring of the asset(s) output to extend the lifetime of the asset(s), and/or otherwise to ensure that the operating conditions for the asset(s) remain in desired levels. Such maintenance is often termed “preventive maintenance,” as the maintenance is performed not in response to a failure but rather to try to prevent a failure of the asset.

In an embodiment, when there is a deviation or deterioration in the output (214) or assets performance from KPI, the user identifies the deviated output and queries a computing system to analyze the root cause of the fault/deviation. In response to an input query from the user, the observer system (212) fetches the relevant information of the associated assets (204, 206, 208 . . . n) and shortlists the relevant information associated with the probable assets that may have contributed to the deviation. The observer system defined above may be a special purpose computer employed for executing the techniques described herein. As a non-limiting example, the user input may specify a query defining the number of hops the user wishes to traverse to determine the data lineage. However, the number of hops cannot exceed the maximum number of assets for which data has been onboarded. The relevant information associated with the assets and shortlisted by the observer system includes asset configuration data, operational functionality data, asset properties, asset identification data, sensor identification data, sensor data, site data, real-time data, live property value data, event data, process data, operational data and fault data etc.

In an embodiment, the relevant information associated with the shortlisted assets that are likely contributors for the deteriorated performance of the asset is fed to the AI/ML model (216) for an intensive or granular analysis. The AI/ML model (216) performs a granular analysis of the relevant information received from the observer system (212) and determines a data lineage chain (218) that identifies the flow of data from a source asset to the destination asset. The data lineage chain determined by the AI/ML model (216) identifies the one or more assets that are responsible for causing the deviation in the output from the KPI. The assets causing the deviation are then ranked in a descending order starting with the asset that is the most probable cause for the deviation. The AI/ML model is further configured to generate and present an interactive output to a user interface. The output is generated by the AI/ML model, may be developed, configured, and/or trained using one or more machine learning algorithms.

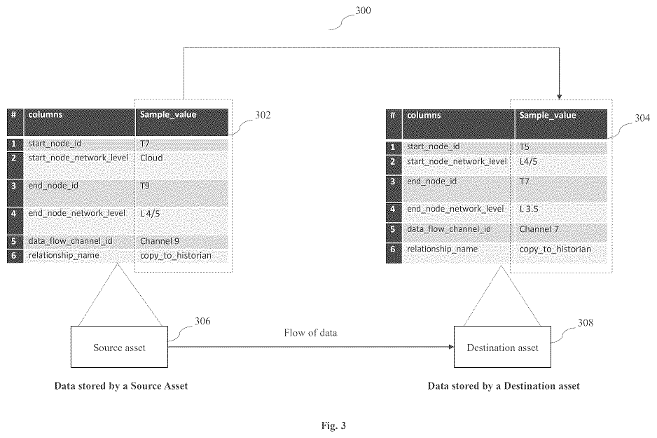

FIG. 3 illustrates the mapping (300) of a data structure (302) of a source asset (306) to a data structure (304) of a destination asset (308) for determining a data lineage in accordance with an embodiment of the present disclosure. The standard of storing the OT-IT data and onboarding the same into OT and IT systems plays a crucial role in accurately determining the data lineage by an AI/ML model and for subsequent root cause analysis. The data elements are required to be stored in a data structure format to enable the AI/ML model to perform the analysis and to resolve the data lineage. FIG. 3 illustrates the mapping of a data structure (302) of a source asset to a data structure (304) of a destination asset for determining a data lineage in accordance with an embodiment of the present disclosure. The assets exchanging data among each other may store the data in a data structure (300). The source asset defined herein and throughout this disclosure refers to the asset responsible for data communication and the destination asset refers to the asset that receives the data communicated by the source asset in an OT-IT environment. In an embodiment, the source asset and the destination asset may be located at the same network level or may be located at different network levels of an industrial enterprise.

In an embodiment, the data elements to be stored in a data structure of the source asset and destination asset comprises network level information of the asset, identification of a data channel for the source asset and the destination asset, asset identification of a source asset and the destination asset, relationship information identifying relationship with the destination asset and one or more tags, each tag comprising a tag value. The source asset (306) and the destination asset (308) are associated with a tag that identifies the metadata associated with the assets. The relationship information identifies the lineage relationship between the source asset (306) and the destination asset (308) and may be defined as either one of Copy_to_historian or Calc_input_historian. In one example, the data is copied from a source asset and communicated to the historian database of the destination asset when the relationship information is defined as Copy_to_historian. In another example, the data is transformed or calculated and communicated to the destination asset for the relationship information Calc_input_historian. The data structure of the source asset (306) is unique from the data structure of the destination asset (308) and comprises values that are capable of generating a lineage record between the source asset and the destination asset.

In an embodiment, to determine a data lineage, the source asset (306) should identify a destination asset (308) to communicate the received data to the assets at same or different levels of an OT environment and to the cloud database located at higher levels L 4/5 of the IT environment of an industrial enterprise. The data lineage is thus determined by an AI model based on a single database query of the cloud database. The standard of storing data and the mapping of the data structure of a source asset and the data structure of the destination asset is essential to generate a lineage record between the source asset and the destination asset. As shown in FIG. 3, the source asset may store data in a data structure that includes start_node_id that identifies the tag associated with the source asset or the destination asset, start_node_network_level that identifies the network level associated with the source asset or the destination asset, an end_node_id that identifies the tag associated with the source asset or the destination asset, an end_node_network_level identifying the network level associated with the source asset or the destination asset, data_flow_channel_id that identifies the channel through which the source and the destination asset communicates the data and the relationship_name identifying the lineage relationship between the source asset and the destination asset.

In an embodiment, the start_node_id, end_node_id, start_node_network_level and the end_node_network_level may identify the source asset or the destination asset depending on the nature of data communication between the assets and the location of the asset in a network level of an industrial enterprise. For example, as illustrated in Table 1 and Table 2 below, the asset associated with a tag T7 is identified as a source asset at network level L4/5 and the said asset associated with the same tag T7 is identified as a destination asset at network Level L3.5 of an industrial enterprise.

In an embodiment, the data structure of the source asset to be stored in a database of an OT-IT system may be represented as disclosed in Table 1 below:

TABLE 1

| # | Columns | Value |
|---|---|---|
| 1 | start_node_id | T9 |
| 2 | start_node_network_level | Cloud |
| 3 | end_node_id | T7 |
| 4 | end_node_network_level | L 4/5 |
| 5 | data_flow_channel_id | Channel 9 |
| 6 | relationship_name | copy_to_historian |

In an embodiment, the data structure of the destination asset to be stored in a database of an OT-IT system may be represented as disclosed in Table 2 below:

TABLE 2

| # | Columns | Value |
|---|---|---|
| 1 | start_node_id | T7 |
| 2 | start_node_network_level | L4 |
| 3 | end_node_id | T5 |
| 4 | end_node_network_level | L 3.5 |
| 5 | data_flow_channel_id | Channel 7 |
| 6 | relationship_name | copy_to_historian |

In an embodiment, the data lineage record is generated by mapping between the data elements of the data structure associated with the source asset and data elements of the data structure associated with the destination asset. The techniques for mapping the data elements of the source asset to the data elements of the destination asset may include instructions stored in the memory relating to the source and destination assets to identify a mapping of data structures in different assets. The example data structure as illustrated in FIG. 3 is non-limiting in nature and may include other data elements that may be stored in a different data structure than as illustrated in FIG. 3.

In an embodiment, the tabular view of the data structure of the source asset and the destination asset stored in a database may be represented as below:

TABLE 3

| # | start_node_id | start_node_network_level | end_node_id | end_node_network_level | data_flow_channel_id | relationship_name |
|---|---|---|---|---|---|---|
| 1 | T1 | L2 | T2 | L3 | Channel 1 | copy_to_historian |
| 2 | T2 | L3 | T4 | L3.5 | Channel 5 | copy_to_historian |
| 3 | T4 | L3.5 | T6 | L4/5 | Channel 6 | copy_to_historian |
| 4 | T6 | L4/5 | T8 | cloud | Channel 8 | copy_to_historian |
| 5 | F1 | L2 | T3 | L3 | Channel 3 | copy_to_historian |
| 6 | T3 | L3 | T5 | L3.5 | Channel 2 | calc_input_to_historian |
| 7 | T2 | L3 | T5 | L3.5 | Channel 4 | calc_input_to_historian |
| 8 | T5 | L3.5 | T7 | L4/5 | Channel 7 | copy_to_historian |
| 9 | T7 | L4/5 | T9 | Cloud | Channel 9 | copy_to_historian |

Table 3 discloses the relevant information and the standard of storing the data for each asset of the plurality of assets in a database for an industrial enterprise. The tabularized data comprises the information with respect to the identification of the source asset, the network level associated with the source asset, the identification of the destination asset, the channel responsible for the communication of the data from a source asset to the destination asset and the lineage information identifying the lineage relationship between the source asset and the destination asset. The asset information of the source and the destination asset as disclosed in table 1 and 2 are stored in a tabularized format in a database thereby providing a common standard of storing the data for both OT and IT systems and ensuring traceability of the data flow across different assets and network levels.

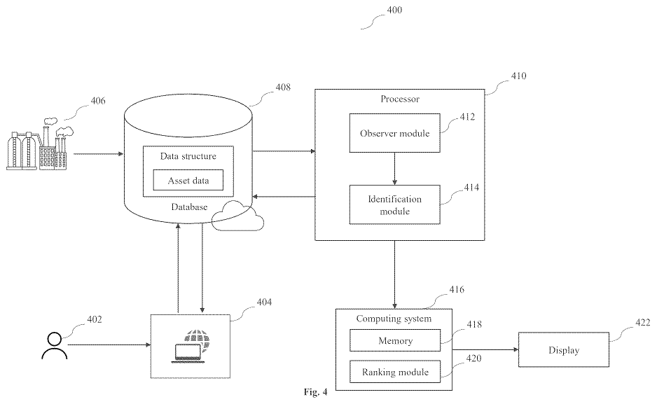

FIG. 4 illustrates an example system (400) that may be configured for determining a data lineage in an integrated OT-IT system in accordance with an embodiment of the present disclosure. The system (400) for determining the data lineage includes a processor (410) comprising modules in communication with a computing system (416) and a database (408). The database as shown in FIG. 4 may be a cloud-based database or an external database configured to be communicatively coupled to the processor for storing the data received from the OT systems. As shown, processor (410) is communicatively coupled to a database (408) and to a computing system to display the determined data lineage in an interactive user interface. The database (408) is configured to accommodate data structures (302, 304) that include asset data for storing asset information in a standard for OT and IT systems as explained in detail below.

The database accommodates the asset information comprising network level information of the asset, identification of a data channel for the asset, identification of a destination asset communicating via the data channel and relationship information identifying relationship with the destination asset. The database as shown in FIG. 4 is capable of running a recursive query in order to ensure that the data lineage can be retrieved from the database within a shorter time frame irrespective of the number of data elements stored therein and the length of the lineage chain. The data lineage can be resolved within a shorter time frame based on a single query as the database supports recursive querying. The database is preferably a cloud-based database for example, GraphDB. The data relating to the assets in the OT-IT system of an industrial enterprise is stored in a data structure for the source and destination asset as shown in Tables 1-3.

In an embodiment a shown in FIG. 4, the processor (410) employs an observer module (412) configured to monitor each of the plurality of assets to identify a deviation from one or more associated key performance indicators (KPI). The one or more assets of an industrial enterprise (406) may malfunction and the output of the asset may exceed a threshold value or a desired level of operation of an asset. The threshold value is defined by a user (402) of an industrial enterprise as a KPI based on the historical performance of the asset. The observer module (412) monitors each asset of the plurality of assets for a deviation from the one or more associated KPIs. The processor (410) further employs an identification module (414) configured to identify if an asset's output deviates from the KPI and further identifies the one or more assets that contribute to the deviation. The identification module (414) retrieves, for each asset that contribute to the deviation, the one or more tags associated with the asset and the tag values.

In an embodiment, the ‘tags’ defined herein and throughout the disclosure refers to metadata labels assigned to various data points, signals, or measurements within the OT layer, such as temperature readings, motor speeds, pressure levels, or other real-time operational data. Tags are often created and managed in the OT systems (like SCADA, PLCs, or DCS systems) to identify, monitor, and organize data from physical assets or processes. Tags are associated with tag values that represent the actual data or measurement associated with a tag at a specific point in time. While the tag itself is a label that identifies a particular data point (for example BoilerA_Temperature), the tag value is the current reading or status of that data point, such as 85° C. Tags help in tracking data lineage by linking raw data in OT systems to the processed data in IT systems, enabling data integrity, and ensuring data origin is traceable across systems.

The identification module (414) retrieves the tags associated with the deviated asset and hence shortlists the possible assets that may be the probable cause for the deviation in the output of the one or more assets. The shortlisted assets and the tag information including tag values are fed to a computing system (416) running an AI/ML model for intensive analysis to generate the data lineage chain and to identify the assets that have contributed to the deviation from the KPI. The computing system (416) is configured to run an AI/ML model to execute software instructions stored in the memory (418) and the instructions may specifically configure the computing system (416) running an AI/ML model to perform the various algorithms embodied in one or more operations described herein when such instructions are executed. The computing system (416) maps and traces the flow of data from its source (e.g., OT sensors or devices) through various processing steps to its end point in IT systems (e.g., databases, analytics platforms). This is achieved through a combination of machine learning, pattern recognition, metadata analysis, and graph-based algorithms.

In an embodiment, the computing system further employs a ranking module (420) configured to rank the one or more assets that deviated from the KPI in a descending order starting with the asset that contributed the most to the deviation from the KPI. The ranking of the deviated assets helps the user in identifying the associated tags and tag values that have deviated and hence helps in analyzing the root cause of the fault. The data lineage chain and the ranking of the one or more assets contributing to the deviation are displayed in an interactive user interface of a display device (422) for necessary action by the user.

In an embodiment, the user may take a precautionary action or may take a corrective action of the one or more assets that have contributed to the deviation to ensure safety and efficiency of the asset, increase the lifetime of operation of the asset and to further reduce the downtime of operation.

In an embodiment, any of the modules in FIG. 4 may be made up of any combination of software, hardware and/or firmware that performs the functions as described and explained herein. In various cases, system (400) may be centralized in one location or dispersed over more than one location. The functionality of system (400) may in some examples be divided differently among the modules illustrated in FIG. 4. Alternatively, to the example shown in FIG. 4, the functionality of system (400) described herein may in some examples be divided into fewer, more and/or different modules than shown in FIG. 4 and/or system (400) may in some examples include additional, less, and/or different functionality than described herein.

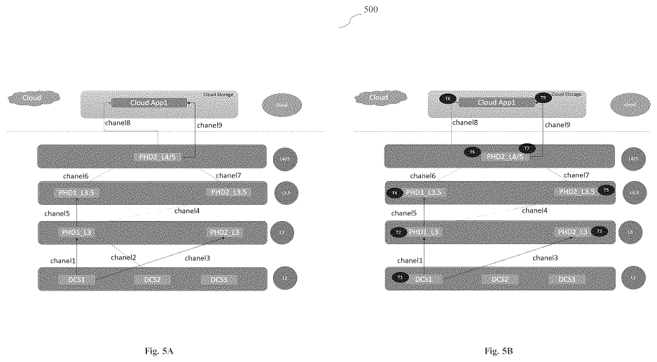

FIGS. 5A and 5B illustrates schematic diagrams illustrating the data flow from an asset located at a network level in the OT environment to the cloud database located in the IT environment in accordance with an embodiment of the present disclosure. FIG. 5A shows that multiple distributed control systems (DCS) are located at Level L2 in the OT environment communicating with the cloud. The data flows from DCS located at Level L2 to historian databases located at Levels L3 and L4/5 and all the way to the cloud app 1 configured at the cloud storage in the IT environment of an industrial enterprise. In an embodiment, a tag T1 may be associated with DCS 1 at Level L2 that acts as the source asset for the flow of data to the assets located at subsequent network levels of an industrial enterprise. The data associated with DCS 1 is required to be stored in a standard compatible for assets located in the OT environment and the one or more applications located in the IT environment.

In an embodiment, to ensure the traceability of data flow from DCS 1 to the cloud database, the standard of data to be stored in the database of the OT-IT systems are as disclosed in Tables 1-3. The data structure and the data elements as disclosed in Tables 1-3 are onboarded into the databases of the OT-IT systems to maintain a single common standard of storing the data and to accurately trace the flow of data to the source asset.

In an embodiment, FIG. 5B shows the journey of a tag T1 associated with the asset ‘DCS 1’ and all the way to the cloud. To trace the journey of a tag T1 associated with DCS 1, the required asset information includes the network level information of the asset, identification of a data channel for the asset, identification of a destination asset communicating via the data channel, relationship information identifying relationship with the destination asset and one or more tags, each tag comprising a tag value. The asset information is required to be stored in a data structure as illustrated in Tables 1-3.

In an embodiment, the OT-IT data is onboarded into the database of OT-IT systems of an industrial enterprise in a standard suitable for both OT and IT systems. The data is stored in a data structure as illustrated in tables 1-3. The observer module (412) monitors each of the plurality of assets to identify a deviation from the associated KPI. The observer module (412) particularly monitors the tags associated with each of the assets to identify a deviation. The identification module (414) on identifying a deviation of the assets performance from the KPI, recursively queries the data to resolve the data lineage for one or more tags associated with the deviated assets. In an example as illustrated in FIG. 5B, the identification module (414) is configured to identify and shortlist the tags that may contribute to the deviation in the performance of the one or more assets. In order to identify the tags associated with the deviated assets, the identification module (414) recursively queries the database to identify the probable assets and the associated tags that may have contributed to the deviation in the performance of the one or more assets. In an example a shown in FIG. 5B, the identification module (414) identifies the probable tags i.e. Tags T2, T6, T8 and T4 that may have contributed to the deviation in the performance of the asset from the KPI.

In an embodiment as disclosed in FIG. 5B, the one or more retrieved tags T2, T6, T8 and T4 that may have contributed to the deviation in the performance of the asset from the KPI are inputted to an AI/ML model for granular analysis and to accurately determine the one or more assets and the associated tags that have contributed to the deviation of the asset's performance from the KPI. The computing system (416) configured with an AI/ML model runs an identification algorithm loaded with instructions stored in the memory to determine a data lineage chain for tracing the flow of data.

The computing system (416) configured to run an AI/ML model maps the data structure including the asset information of the source asset i.e. T8 with the data structure including the asset information of the immediate destination asset i.e. T6. The data structure is mapped based on the data elements associated with the source asset and the destination asset namely, the end_node_id, start node_id, start_node_network_level, end_node_network_level, data_flow_channel_id and relationship name as discussed in FIG. 3. As the database supports recursive querying, a further query of resolving the data lineage is automatically carried out without further instructions from the computing system. The data lineage is resolved by mapping the data structure of the source asset associated with Tag T6 with the data structure of the destination asset associated with Tag T4. This recursive query of the database may be carried out on an asset for which the user has onboarded the OT data. As shown in FIG. 5B, the user has onboarded the OT-IT data for assets located at network levels L2 to LA/L5. As the data is onboarded for all the OT systems from L2 to LA/L5, The AI/ML model determines the data lineage chain for Tag T8 as follows:

Data lineage chain for Tag T8: T8→T6→T4→T2→T1

In an example as shown in FIG. 5B, the AI/ML model determines that the Tag T8 configured at the cloud App 1 of the IT environment received the data from T8 that was copied from tags T6, T4, T2 and T1 in the order as illustrated above. In an embodiment, to determine the data lineage chain for T9, the system as disclosed in FIG. 4 by employing the techniques as described in FIG. 5B determines the data lineage chain as follows:

Data lineage chain for Tag T9: T9→T7→T5→T2→T1

The AI/ML model is further configured to rank the one or more assets that malfunctioned based on the deviation from the KPI in a descending order starting with the asset that contributed the most to the deviation from the KPI in a descending order. The ranking of the assets contributing to the deviation helps the user in identifying the associated tags and tag values that have deviated and hence helps in analyzing the root cause of the fault or deviation from the KPI. The data lineage chain and the ranking of the one or more assets contributing to the deviation are displayed as an output in an interactive user interface to the user for necessary action. In an embodiment, the user may take a precautionary action or may take a corrective action of the one or more assets that have contributed to the deviation to ensure safety and efficiency of the asset, increase the lifetime of operation of the asset and to further reduce the downtime of operation.

In an embodiment, the ranking of the one or more assets contributing to the deviation may be presented to the user via the user interface as follows: T4>T2>T6. The ranking as provided herein is generated by the AI/ML model based from the data lineage chain

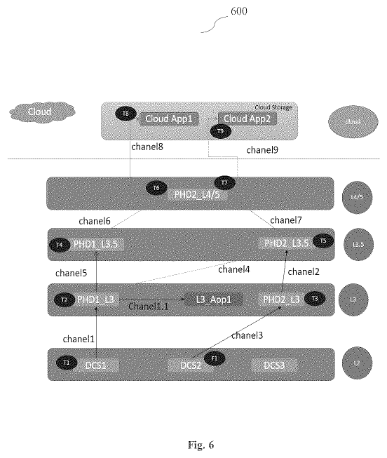

FIG. 6 illustrates a schematic diagram illustrating the tracing of data flow from one or more applications configured for an asset located at an OT network level to one or more applications configured in the cloud database at an IT network level in accordance with an embodiment of the present disclosure. As shown in FIG. 6, there are three applications Cloud App 1 and Cloud App 2 configured in the cloud storage at the IT network level of an industrial enterprise and L3_App 1 is configured for an OT system at network level L3 in an embodiment of the present disclosure.

Each of the applications as discussed above have their own assets (and other configuration items) and hierarchy defined that may or may not have any similarity with any other asset. All the applications use OT data (viz. tags and associated tag value) for calculation. Having set up and onboarded the L2 to L5 OT applications, much of the lineage of data can be traced by tag lineage without having any additional configurations.

In an embodiment as disclosed in FIG. 6, Cloud Appl is a KPI calculation engine that uses L5 historian tag values to calculate KPIs. L3_Appl is an event and alarm management system that uses certain L3 level tags to calculate event values and alarms. In the example as illustrated in FIG. 6, by following the tag lineage it is possible to establish the lineage of items and configuration across those assets.

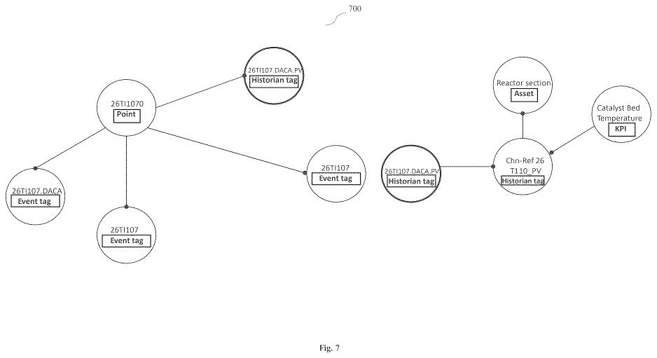

FIG. 7 illustrates an example interactive user output (700) generated by an AI/ML model in accordance with an embodiment of the present disclosure. In an embodiment, the user on identifying a deviation in the performance of the one or more assets may query the database to determine a data lineage and identify the one or more assets that contributed to the deviation from the KPI. FIG. 7 shows an example output displayed in an interactive manner to a user interface. FIG. 7 identifies the source asset and the destination asset and the flow of data from a source asset to the destination asset.

In an example as illustrated in FIG. 7, the source asset for the assets associated with the historian tag 26TI107.DACA.PV, event tag 26TI107 and event tag 26TI107.DACA is the asset associated with the tag 26TI1070. The combination of alphabets and numerical (for e.g. 26TI107) denotes the tag identifiers and the alphabets ‘DACA.PV’ refers to the relationship of the asset with the other asset. DACA refers to the relationship information ‘Calc_input’ in an embodiment of the present disclosure. In an example, to trace the data lineage for the asset associated with the tag ‘26TI107.DACA.PV’ as illustrated in FIG. 7, the user may retrieve the lineage of data for the said asset on a simple click of a button performed on a computing system. The lineage of data for tag ‘26TI107.DACA.PV’ is determined as shown in FIG. 7 in accordance with an embodiment of the present disclosure.

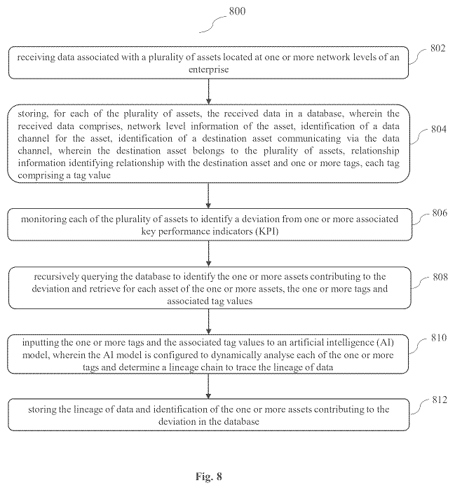

FIG. 8 illustrates a method (800) for determining data lineage in OT-IT systems in accordance with an embodiment of the present disclosure. The method for determining the lineage of data in a connected system comprises receiving (802) data associated with a plurality of assets located at one or more network levels of an industrial enterprise. The received data for each of the plurality of assets are stored (804) in a database, wherein the received data comprises network level information of the asset, identification of a data channel for the asset, identification of a destination asset communicating via the data channel, relationship information identifying relationship with the destination asset and one or more tags, each tag comprising a tag value.

Each of the plurality of assets are monitored (806) to identify a deviation from one or more associated key performance indicators (KPI) that are pre-defined by a user in the database. The database is then recursively queried (808), in response to the deviation to identify the one or more assets contributing to the deviation and to retrieve for each asset of the one or more assets, the one or more tags and associated tag values. The one or more tags and the associated tag values are fed (810) to an artificial intelligence (AI) model, wherein the AI model is configured to dynamically analyse each of the one or more tags for determining a lineage chain to trace the lineage of data. The lineage of data and identification of the one or more assets contributing to the deviation is stored (812) in the database.

The one or more tags in the data lineage chain are then ranked by the AI model based on the contribution to the deviation in a descending order and an interactive output is provided to an user interface. The AI model can now automatically determine new lineage of data based on the historical lineage data stored in the database. Further, as the database is configured to support recursive querying, the analysis is accurate, less time consuming and efficient.

Embodiment of the present disclosure features a system for determining lineage of data comprising: a processor, a memory storing program instructions which, when executed by the processor, causes the processor to: receive data associated with a plurality of assets located at one or more network levels of an industrial enterprise, store for each of the plurality of assets, the received data in a database, wherein the received data comprises, network level information of the asset, identification of a data channel for the asset, identification of a destination asset communicating via the data channel, wherein the destination asset belongs to the plurality of assets, relationship information identifying relationship with the destination asset and one or more tags, each tag comprising a tag value. The processor is further configured to monitor each of the plurality of assets to identify a deviation from one or more associated key performance indicators (KPI). In response to the deviation, a recursive query is performed on the database to identify the one or more assets contributing to the deviation and retrieve for each asset of the one or more assets, the one or more tags and associated tag values. The one or more tags and the associated tag values are inputted to an artificial intelligence (AI) model, wherein the AI model is configured to dynamically analyse each of the one or more tags and =determine a lineage chain to trace the lineage of data. The lineage of data and identification of the one or more assets contributing to the deviation are then stored in the database.

Embodiments of the present disclosure features a non-transitory computer readable medium storing software for determining lineage of data, the software including instructions for causing a computing system to: receive data associated with a plurality of assets located at one or more network levels of an enterprise, store for each of the plurality of assets, the received data in a database, wherein the received data comprises, network level information of the asset, identification of a data channel for the asset, identification of a destination asset communicating via the data channel, wherein the destination asset belongs to the plurality of assets, relationship information identifying relationship with the destination asset and one or more tags, each tag comprising a tag value. The software including instructions further causes a computing system to: monitor each of the plurality of assets to identify a deviation from one or more associated key performance indicators (KPI), in response to the deviation, recursively query the database to identify the one or more assets contributing to the deviation and retrieve for each asset of the one or more assets, the one or more tags and associated tag values, input the one or more tags and the associated tag values to an artificial intelligence (AI) model, wherein the AI model is configured to dynamically analyse each of the one or more tags and determine a lineage chain to trace the lineage of data and store the lineage of data and identification of the one or more assets contributing to the deviation in the database.

The techniques as described in this disclosure provides for adopting standardized formats and storage protocols to allow for smooth integration and data exchange between OT and IT systems. Storing data in a standard acceptable for both OT and IT systems and onboarding the same in the database of the said OT-IT systems ensures in maintaining the integrity of data when data flows from a source asset to a destination asset. The standard of storing data is significant as assets from the OT environment and IT environment need to access and act on the same data, to reduce errors in data when data flows from one asset to the other. Thus, the standards of storing data ensure that data lineage is traceable across both OT and IT systems. Further, adopting and adhering to these standards enables organizations to maintain data integrity, foster interoperability, meet regulatory requirements.

The techniques described herein enables an AI/ML model to uncover the hidden patterns with the help of historical data and validation techniques and make decisions to provide useful insight to downstream Operational Technology (OT) systems for automating a workflow. Further, onboarding various OT system data with a defined data structure in a database enables a computing system configured with an AI/ML model to efficiently and quickly determining the data lineage of connected systems and for diagnosis and deviation prediction from KPI. The data lineage chain determined in accordance with the techniques described herein traces the lineage of data and enables the computing system to rank the assets that are responsible for causing a deviation in the performance of the asset from the KPI. Furthermore, as the lineage data is stored and dynamically updated in the database, the computing system running an AI/ML model can over the period looking at the existing data stored in the database further hidden patterns and can auto create new data to discover new lineage and patterns of data.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a mark up language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices, magnetic disks, e.g., internal hard disks or removable disks, magneto-optical disks and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well for example, feedback provided to the user can be any form of sensory feedback, e.g., visual feedback, auditory feedback, or tactile feedback and input from the user can be received in any form, including acoustic, speech, or tactile input. In addition, a computer can interact with a user by sending documents to and receiving documents from a device that is used by the user for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for determining lineage of data comprising:
receiving data associated with a plurality of assets located at one or more network levels of an enterprise;
storing, for each of the plurality of assets, the received data in a database, wherein the database is a cloud-based database configured to support recursive querying, and wherein the received data comprises,
network level information of the asset;
identification of a data channel for the asset, wherein the data channel is a channel through which data is communicated between a source asset and a destination asset;
identification of the destination asset communicating via the data channel, wherein the destination asset belongs to the plurality of assets;
relationship information identifying relationship with the destination asset;
one or more tags, each tag comprising a tag value;
monitoring each of the plurality of assets to identify a deviation from one or more associated key performance indicators (KPI);
in response to the deviation, recursively querying the database to identify the one or more assets contributing to the deviation and to retrieve, for each asset of the one or more assets, the one or more tags and associated tag values;
inputting the one or more tags and the associated tag values to an artificial intelligence (AI) model, wherein the AI model is configured to analyse each of the one or more tags and determine a lineage chain to trace the lineage of data; and
storing the lineage of data and identification of the one or more assets contributing to the deviation in the database.

2. The method of claim 1, wherein monitoring each of the plurality of assets comprises: monitoring based on the one or more tags and the associated tag values of the one or more assets contributing to the deviation.

3. The method of claim 1, wherein the received data is stored in a data structure in the database.

4. The method of claim 3, further comprising: mapping the data structure of the one or more assets, based on the received data.

5. The method of claim 1, wherein the one or more assets comprises: the source asset or the destination asset.

6. The method of claim 3, wherein the data structure of the destination asset differs from the data structure of the source asset.

7. The method of claim 1, wherein the one or more tags includes metadata associated with the plurality of assets.

8. The method of claim 1, wherein the relationship information identifies transformation of data navigating from the source asset to the destination asset.

9. The method of claim 1, wherein identifying the one or more assets contributing to the deviation comprises: ranking the one or more tags of the lineage chain based on the contribution to the deviation from the one or more associated KPI.

10. The method of claim 1, wherein recursively querying the database further comprises: retrieving the one or more tags in response to a query defined by a user.

11. The method of claim 1, further comprising: determining, by the AI model, the lineage of data based on historical lineage data stored in the database.

12. The method of claim 1, wherein the one or more KPI is a set threshold value based on historical performance of the plurality of assets.

13. The method of claim 1, further comprising: displaying the lineage of data to the user in an interactive user interface.

14. A system for determining lineage of data comprising:
a processor;
a memory storing program instructions which, when executed by the processor, causes the processor to:
receive data associated with a plurality of assets located at one or more network levels of an enterprise;
store for each of the plurality of assets, the received data in a database, wherein the database is a cloud-based database configured to support recursive querying, and wherein the received data comprises,
network level information of the asset;
identification of a data channel for the asset, wherein the data channel is a channel through which data is communicated between a source asset and a destination asset;
identification of the destination asset communicating via the data channel, wherein the destination asset belongs to the plurality of assets;
relationship information identifying relationship with the destination asset;
one or more tags, each tag comprising a tag value;
monitor each of the plurality of assets to identify a deviation from one or more associated key performance indicators (KPI);
in response to the deviation, recursively query the database to identify the one or more assets contributing to the deviation and to retrieve, for each asset of the one or more assets, the one or more tags and associated tag values;
input the one or more tags and the associated tag values to an artificial intelligence (AI) model, wherein the AI model is configured to analyse each of the one or more tags and determine a lineage chain to trace the lineage of data; and
store the lineage of data and identification of the one or more assets contributing to the deviation in the database.

15. The system of claim 14, wherein the one or more assets comprises: the source asset or the destination asset.

16. The system of claim 14, wherein the relationship information identifies transformation of data navigating from the source asset to the destination asset.

17. The system of claim 14, comprising: ranking the one or more tags of the lineage chain based on the contribution to the deviation from the one or more associated KPI.

18. The system of claim 14, wherein the one or more KPI is a set threshold value based on historical performance of the plurality of assets.

19. The system of claim 14, comprising: displaying the lineage of data to a user in an interactive user interface.

20. A non-transitory computer readable medium storing software for determining lineage of data, the software including instructions for causing a computing system to:
receive data associated with a plurality of assets located at one or more network levels of an enterprise;
store for each of the plurality of assets, the received data in a database, wherein the database is a cloud-based database configured to support recursive querying, and wherein the received data comprises,
network level information of the asset;
identification of a data channel for the asset, wherein the data channel is a channel through which data is communicated between a source asset and a destination asset;
identification of the destination asset communicating via the data channel, wherein the destination asset belongs to the plurality of assets;
relationship information identifying relationship with the destination asset;
one or more tags, each tag comprising a tag value;
monitor each of the plurality of assets to identify a deviation from one or more associated key performance indicators (KPI);
in response to the deviation, recursively query the database to identify the one or more assets contributing to the deviation and to retrieve, for each asset of the one or more assets, the one or more tags and associated tag values;
input the one or more tags and the associated tag values to an artificial intelligence (AI) model, wherein the AI model is configured to analyse each of the one or more tags and determine a lineage chain to trace the lineage of data; and
store the lineage of data and identification of the one or more assets contributing to the deviation in the database.
